(19) United States
(12) Patent Application Publication
(10) Pub. No.: US 2012/0217198 A1
(43) Pub. Date: Aug. 30, 2012

(54) BI-FLOW FILTER DRIER

(75) Inventors: Feng Chen, Zhejiang (CN); Linping Wu, Zhejiang (CN)

(73) Assignee: Zhejiang Sanhua Climate and Appliance Controls Group Co., Ltd., Zhejiang (CN)

(21) Appl. No.: 13/405,531

(22) Filed: Feb. 27, 2012

(30) Foreign Application Priority Data
Feb. 28, 2011 (CN) 201110048348.4

(51) Int. Cl. B01D 29/00

(52) U.S. Cl. 210/323.1

(57) ABSTRACT

Disclosed herein is a bi-flow filter drier including a cartridge and a filter core located inside the cartridge. A filter sheet is provided at each of two ends of the filter core. The bi-flow filter drier further includes at least one intermediate filter sheet positioned between the cartridge and the filter core. In the bi-flow filter drier of the application, the refrigerant flows into the filter core after being filtered by the intermediate filter sheet, and flows through the center hole of the filter core towards the filter sheet at one end of the filter core, and then flows out of the filter drier after being re-filtered. This bi-flow filter drier allows the refrigerant to pass through the filter sheets twice, and the filtration capacity and the filtration precision are improved. The intermediate filter sheet may protect the filter core to prolong the service life thereof.

The present application claims the benefit of priority to Chinese patent application No. 201110048348.4 titled “BI-FLOW FILTER DRIER”, filed with the Chinese State Intellectual Property Office on Feb. 28, 2011. The entire disclosure thereof is incorporated herein by reference.

### FIELD OF THE INVENTION

This application relates to the technical field of filters, in particular to a bi-flow filter drier.

### BACKGROUND OF THE INVENTION

A bi-flow filter drier has functions of absorbing moisture and residual acid and filtering, is mainly used in a bi-flow loop in a heat pump system, and is particularly applicable to a refrigerating system with more impurities therein to filter the impurities in the pipe line of the refrigerating system and to lock the impurities in the filter drier.

Referring to FIG. 1, a schematic view of the structure of a conventional bi-flow filter drier is shown.

The bi-flow filter drier includes a cartridge 60. A left end cover 10 and a right end cover 100 are provided at two ends of the cartridge 60 respectively, and are connected to a left connecting pipe and a right connecting pipe respectively. A left one-way valve member 20, a left blocking net, a left sieve 30, a left filter sheet 40, a filter core 50, a right filter sheet 70, a right sieve 80, a right blocking net and a right one-way valve member 90 are provided inside the cartridge 60 in sequence from left to right. The left one-way valve member 20 and the right one-way valve member 90 may be used to realize the bidirectional flow of the refrigerant. The one-way valve members each have a surrounding hole and a center hole, and the refrigerant may flow in via the surrounding hole or out via the center hole.

Referring to FIG. 2, a schematic view of flowing routes of the refrigerant inside the bi-flow filter drier shown in FIG. 1 is shown.

After entering into the bi-flow filter drier via the left end cover 10, the refrigerant flows into the inside of the cartridge 60 through the surrounding hole of the left one-way valve member 20, and mainly flows towards the region between the periphery of the central filter core 50 and the inner wall of the cartridge 60, and then infiltrates through the central filter core 50. Then, the refrigerant passes through a center hole of the central filter core 50 and flows towards the right filter sheet 70, and passes through the right sieve 80 and the right blocking net, and then flows out of the filter drier via the center hole of the right one-way valve member 90. When the refrigerant enters in the filter drier via the right connecting pipe, the flowing process of the refrigerant is contrary to the above process, which will not be described in detail herein. When flowing through the bi-flow filter drier, the refrigerant passes through the filter core 50, passes through the filter sheet once and passes through the sieve once. Thus, the impurities of the refrigerant are mainly filtered by the left filter sheet 40 or the right filter sheet 70. The filter core 50 is mainly used for absorbing elements such as moisture and residual acid. The left sieve 30 or the right sieve 80 not only may filter a part of the impurities, but also may fix the position of the filter sheets to some extent.

In the technical solution of the prior art, due to the structural design of the bi-flow filter drier, the refrigerant circulates along a specified route after entering in the filter drier, specifically, only passes through the sieve once and the filter sheet once in the filter drier. Thus, the filtration precision of the filter drier is not high enough to fully lock the impurities, that is, part of the impurities still flow out of the filter drier and enter into the refrigerating system. The total amount of the filtered impurities is relatively less, thus the filtration capacity is insufficient.

Therefore, the technical problem to be solved by the person skilled in the art is to provide a bi-flow filter drier having higher filtration precision and stronger filtration capacity.

### SUMMARY OF THE INVENTION

The object of the present application is to provide a bi-flow filter drier having higher filtration precision and stronger filtration capacity.

For solving the above technical problems, the present application provides a bi-flow filter drier including a cartridge and a filter core located inside the cartridge, a filter sheet being provided at each of two ends of the filter core, wherein the bi-flow filter drier further comprises at least one intermediate filter sheet positioned between the cartridge and the filter core.

Preferably, a periphery of a cross section of the intermediate filter sheet is of polygonal shape, and side edges of the intermediate filter sheet abut against an inner wall of the cartridge. The intermediate filter sheet has an axial through hole, and a wall of the axial through hole abuts against the periphery of the filter core.

Preferably, the number of the intermediate filter sheet is more than one, and an overall axial thickness of the intermediate filter sheets is equal to an axial length of the filter core.

Preferably, an axial center hole is provided in each of the filter sheets at two ends of the filter core.

Preferably, the intermediate filter sheets are made of glass wool board and the filter sheets at two ends of the filter core are made of glass wool felt.

Preferably, the glass wool board has a density ρ₁ meeting an expression of 25 kg/m³≦ρ₁≦50 kg/m³, and the glass wool felt has a density ρ₂ meeting an expression of 10 kg/m³≦ρ₂≦40 kg/m³.

Preferably, a minimum thickness of the intermediate filter sheets is larger than 5 mm

The bi-flow filter drier provided by the present application includes at least one intermediate filter sheet positioned between the cartridge and the filter core. When entering in the cartridge, the refrigerant flows through a surrounding hole of the one-way valve member towards the region between the periphery of the filter core and the inner wall of the cartridge where the intermediate filter sheet is provided. Thus, the refrigerant flows into the filter core after being filtered by the intermediate filter sheet, and flows through the center hole of the filter core towards the filter sheet at one end of the filter core after being dried by the filter core, and then flows out of the filter drier after being re-filtered. Thus, in the bi-flow filter drier with the above structure, since the refrigerant passes through the filter sheets twice, the filtration capacity and the filtration precision of the filter drier are improved. In addition, the intermediate filter sheet provided between the periphery of the filter core and the inner wall of the cartridge may protect the filter core so as to prolong the service life of the filter core.

### BRIEF DESCRIPTION OF THE DRAWINGS

FIG. 1 is a schematic view of the structure of a conventional bi-flow filter drier;

FIG. 2 is a schematic view of flowing routes of the refrigerant inside the bi-flow filter drier shown in FIG. 1;

FIG. 3 is a schematic view of the structure of a bi-flow filter drier according to an embodiment of the present application;

FIG. 4 is a schematic view of flowing routes of the refrigerant inside the bi-flow filter drier in FIG. 3;

FIG. 5 is a partial enlarged view of part A in FIG. 4; and

FIG. 6 is a schematic view of the structure of a hexagonal intermediate filter sheet of a bi-flow filter drier according to another embodiment of the present application.

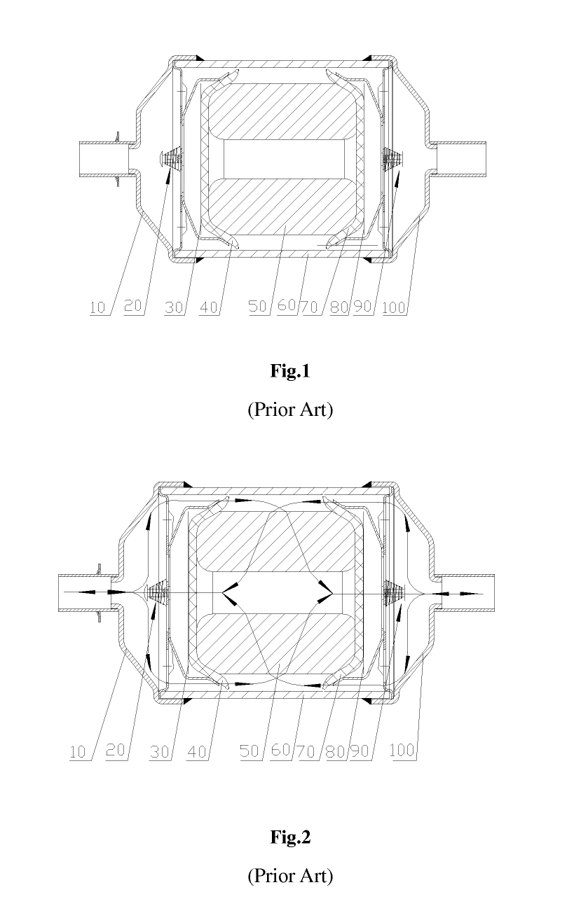

### DETAILED DESCRIPTION OF THE EMBODIMENTS

The object of the present application is to provide a bi-flow filter drier having best filtration capacity while satisfying the requirement of the fluid flux.

For the person skilled in the art to better understand the technical solution of the present application, the present application will be described in detail in conjunction with drawings and embodiments hereinafter.

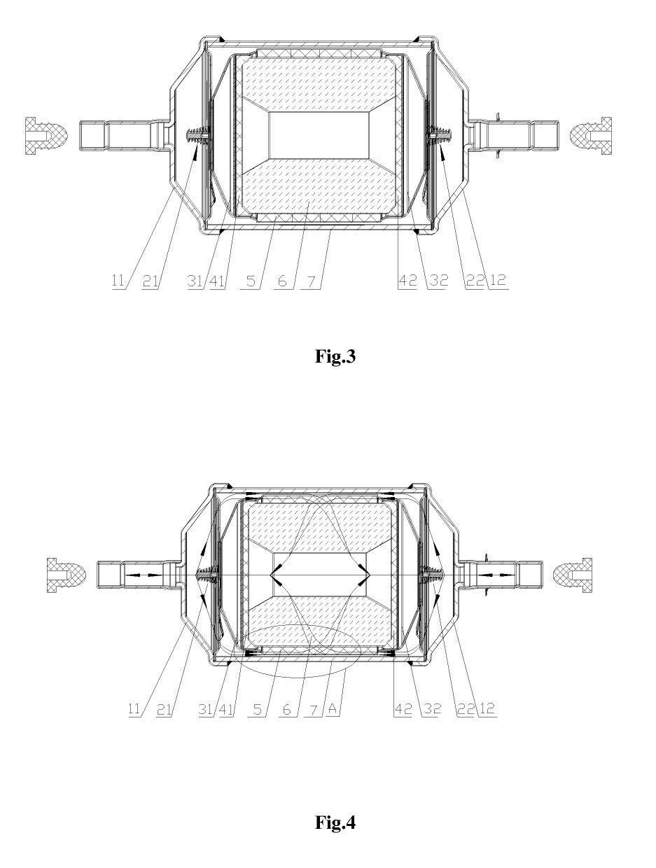

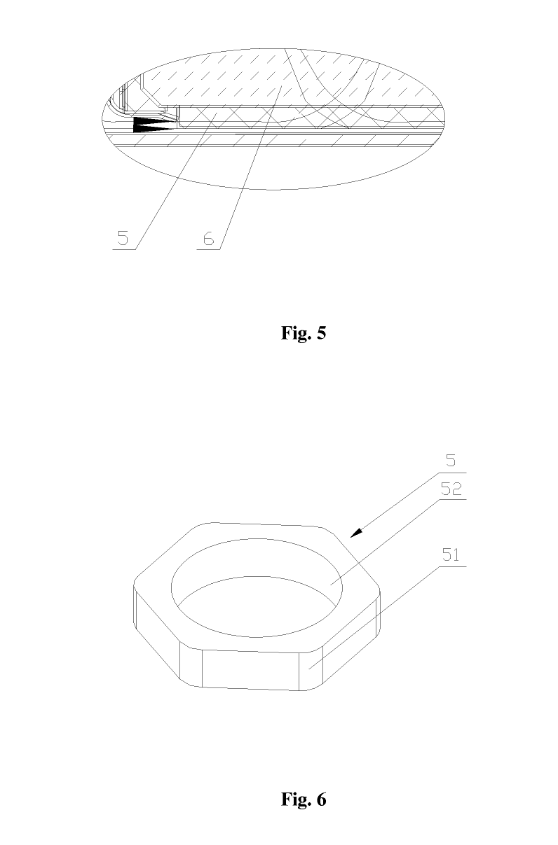

Referring to FIGS. 3 to 5, FIG. 3 is a schematic view of the structure of a bi-flow filter drier according to an embodiment of the present application; FIG. 4 is a schematic view of flowing routes of the refrigerant inside the bi-flow filter drier in FIG. 3; and FIG. 5 is a partial enlarged view of part A in FIG. 4.

The bi-flow filter drier provided by the present application includes a cartridge 7. End covers, i.e. a left end cover 11 and a right end cover 12 as shown in FIG. 3, are provided at two ends of the cartridge 7 respectively, and are connected to connecting pipes for circulation of the refrigerant respectively. For realizing the bi-flow function, the refrigerant entered into the left end cover 11 or the right end cover 12 needs to flow through one-way valve members each having a surrounding hole and a center hole. The refrigerant flows into the cartridge 7 via a surrounding hole of a left one-way valve member 21, and flows out of the cartridge 7 via a center hole of a right one-way valve member 22. Alternatively, the refrigerant flows into the cartridge 7 via a surrounding hole of the right one-way valve member 22, and flows out of the cartridge 7 via a center hole of the left one-way valve member 21. A filter core 6 is provided inside the cartridge 7, and has an axial center hole. The term “axial” herein refers to the axial direction of the cartridge 7. The filter core 6 may employ a molecular sieve to absorb substances such as moisture and residual acid in the refrigerant for performing drying function. A left filter sheet 41 and a right filter sheet 42 are provided at two ends of the filter core 6 respectively to filter the impurities in the refrigerant. A left sieve 31 and a right sieve 32 may also be provided at two ends of the filter core 6. In addition, a left blocking net and a right blocking net may be provided adjacent to the left sieve 31 and the right sieve 32 respectively. The material of the sieves and the blocking nets is harder. The sieves and the blocking nets may fix the position of the left filter sheet 41 and the right filter sheet 42 by cooperating with the filter core 6. The components described above are provided in the following sequence: the left end cover 11, the left one-way valve member 21, the left blocking net, the left sieve 31, the left filter sheet 41, the filter core 6, the right filter sheet 42, the right sieve 32, the right blocking net, the right one-way valve member 22 and the right end cover 12.

The bi-flow filter drier provided by the present application further includes at least one intermediate filter sheet 5 located between the cartridge 7 and the filter core 6. As shown in FIG. 4, when entering into the cartridge 7 via the left end cover 11, the refrigerant flows through the surrounding hole of the left one-way valve member 21 towards the region between the periphery of the filter core 6 and the inner wall of the cartridge 7 where the intermediate filter sheet 5 is provided. Thus, the refrigerant flows into the filter core 6 after being filtered by the intermediate filter sheet 5, and flows through the center hole of the filter core 6 towards the right filter sheet 42 after being dried by the filter core 6, and then flows out of the filter drier after being re-filtered. When the refrigerant enters into the cartridge 7 from the right end cover 12, the route of drying and filtering is contrary to the above-described route, which will not be described in detail herein.

Therefore, in the bi-flow filter drier with the above structure, the refrigerant passes through the filter sheets twice, so the filtration capacity and the filtration precision of the filter drier are improved. In addition, the intermediate filter sheet 5 provided between the periphery of the filter core 6 and the inner wall of the cartridge 7 may protect the filter core 6 so as to prolong the service life of the filter core 6.

Referring to FIG. 6, it is a schematic view of the structure of a hexagonal intermediate filter sheet of a bi-flow filter drier according to another embodiment of the present application.

In another embodiment, a polygonal intermediate filter sheet 5 may be employed, that is, the periphery of the cross section of the intermediate filter sheet 5 is of polygonal shape having side edges 51 on the periphery thereof. When assembling the intermediate filter sheet 5, the side edges 51 abut against the inner wall of the cartridge 7 so as to effectively position the intermediate filter sheet 5, thereby ensuring that the capacity of the refrigerant circulating inside the filter will not be affected. In the case of the intermediate filter sheet 5 of polygonal structure, the side edges 51 thereof are fitted with the inner wall of the cartridge 7, and there are gaps between multiple lateral surfaces of the intermediate filter sheet 5 and the inner wall of the cartridge 7. In this way, part of the refrigerant flows directly into the intermediate filter sheet 5, and the other part of the refrigerant may flows through the gaps towards the outside of the intermediate filter sheet 5, and then flows into the intermediate filter sheet 5 and the molecular sieve from the outside of the intermediate filter sheet 5 so as to provide the distributaries of the refrigerant and reduce the resistance force. Thus, the polygonal intermediate filter sheet 5 may improve the fluid flux of the filter drier. The hexagonal intermediate filter sheet 5 as shown in FIG. 6 has a symmetrical structure, and is easy to be positioned in assembling. Certainly, the intermediate filter sheet 5 may also be octagon, decagon or the like as long as the intermediate filter sheet 5 has gaps for circulation of part of the refrigerant.

The material of the intermediate filter sheet 5 is soft. Thus, the diameter of the circumcircle of the polygonal intermediate filter sheet 5 may be slightly larger than the inner diameter of the cartridge 7. In the case of the intermediate filter sheet 5 of hexagonal structure, the diameter of the circumcircle, i.e. the length of the longest diagonal of the hexagon, may be about 0.5 mm-8 mm larger than the diameter of the cartridge 7, so as to effectively fit the polygonal intermediate filter sheet 5 with the cartridge 7 without being loosened, and to facilitate the assembly.

The intermediate filter sheet 5 may also has an axial through hole 52, and the wall of the axial through hole 52 is fitted with and abuts against the periphery of the filter core 6. As shown in FIG. 3, the intermediate filter sheet 5 has a center circular hole. In assembling the filter core 6 may be placed in the center circular hole of the intermediate filter sheet 5. The shape of the cross section of the periphery of the filter core 6 is circular. The wall of the center circular hole is fully fitted with the filter core 6, thus a contact area is relatively large so as to effectively position the intermediate filter sheet 5 and the filter core 6. Due to the fully contact between the periphery of the filter core 6 and the intermediate filter sheet 5, the refrigerant has to pass through the intermediate filter sheet 5 to flow into the filter core 6, thereby ensuring that filtration occurs twice.

The bi-flow filter drier of the above structure has relatively high filtration capacity and filtration precision while ensuring the fluid flux. Referring to table 1, it shows experimental data of the fluid flux and the filtration capacity of the bi-flow filter drier provided with the intermediate filter sheet and of the bi-flow filter drier without the intermediate filter sheet.

TABLE 1

| | | Percentage of the |
|---|---|---|
| Experimental conditions | Fluid flux | filtered impurities |
| There is no intermediate filter sheet in the | a | 21% |
| filter drier | | |
| The intermediate filter sheet is provided | 0.902a | 70% |
| in the filter drier | | |
| The hexagonal intermediate filter sheet is | 0.975a | 69% |
| provided in the filter drier | | |

As can be seen from table 1, in the case of the hexagonal intermediate filter sheet 5 being provided in the filter drier, the fluid flux is almost not affected, while the filtration capacity is improved by more than two times.

Further, multiple intermediate filter sheets 5 may be provided. The overall thickness of the multiple intermediate filter sheets 5 is equal to the axial length of the filter core 6, that is, the intermediate filter sheets 5 fill the gap between the periphery of the filter core 6 and the inner wall of the cartridge 7 so as to achieve better filter effect. As shown in FIG. 3, four intermediate filter sheets 5 in total are employed. Apparently, the number of the intermediate filter sheets 5 is related to the thickness of single intermediate filter sheet 5. Preferably, a minimum thickness of the intermediate filter sheets 5 is larger than 5 mm Considering the process feasibility of manufacturing the polygonal intermediate filter sheet 5, the thickness of the thinnest part of the intermediate filter sheet 5 should be larger than 5 mm so as to ensure that the polygonal intermediate filter sheet 5 will not be broken in a stamping process. Provided that the intermediate filter sheets 5 fill the region between the periphery of the filter core 6 and the inner wall of the cartridge 7, due to a fixed axial length of the above region, the more the number of the intermediate filter sheets 5 assembled is, the more tightly the intermediate filter sheets 5 are pressed, the stronger the capacity of filtering the impurities is. Of course, the number of the intermediate filter sheets 5 may be increased or decreased according to the practical situation.

The intermediate filter sheets 5 may be made of glass wool board, and the filter sheets at two ends of the filter core 6 may be made of glass wool felt. Glass wool board is a sheet material product with a certain strength made from centrifugal glass wool through the solidification process. Glass wool board has relatively dense glass fiber net structure, thus has high filter capacity and may also satisfy the requirement of fluid flux. Glass wool felt is formed by adding thermosetting adhesive into glass fibers and then heating, solidifying and shaping the resultant matter. Compared with glass wool board, glass wool felt has a sparser glass fiber net structure, thus has a lower filter capacity, but may satisfy higher requirement of fluid flux.

For the bi-flow filter drier with the above structure, the filtration of the intermediate filter sheet 5 is an important step in the whole filtration process. In order to ensure the filtration effect, the intermediate filter sheet 5 is made of glass wool board having high filtration capacity. Besides, the intermediate filter sheet 5 is mainly positioned by press fitting. The material of glass wool board is not easily deformed after being positioned so as to maintain a stable performance. The filter sheets at two ends of the filter core 6 are located at the outlet of the refrigerant, resulting in a higher requirement for fluid flux, and thus are made of flexible glass wool felt so as to re-filter the refrigerant filtered by the intermediate filter sheet 5 and fully satisfy the requirement for fluid flux. Further, since the filter sheets at two ends of the filter core 6 are positioned by the filter core 6, the blocking nets and the sieves, the flexible glass wool felt will not affect the stability of the position of the filter sheets at two ends of the filter core 6.

The glass wool board may have a density ρ₁ meeting an expression of 25 kg/m³≦ρ₁≦50 kg/m³, and the glass wool felt may have a density ρ₂ meeting an expression of 10 kg/m³≦ρ₂≦40 kg/m³. The bi-flow filter drier within the above numerical ranges has better filtration capacity and higher fluid flux.

Referring to table 2, it shows experimental data of the filtration capacity and the fluid flux of the bi-flow filter driers with different parameters by the same experimental method as table 1, in which the intermediate filter sheet is made of glass wool board and the filter sheets at two ends of the filter core 6 are made of glass wool felt.

TABLE 2

| | | Percentage of |
|---|---|---|
| | | the filtered |
| Experimental conditions | Fluid flux | impurities |
| The filter sheets at two ends: ρ₂ = 25 kg/m³, | b | 67% |
| t₂ = 10 mm, d₂ = 10 μm; | | |
| The intermediate filter sheets: ρ₁ = 10 kg/m³, | | |
| t₁ = 20 mm, d₁ = 15 μm | | |
| The filter sheets at two ends: ρ₂ = 35 kg/m³, | 0.99b | 69% |
| t₂ = 30 mm, d₂ = 5 μm; | | |
| The intermediate filter sheets: ρ₁ = 30 kg/m³, | | |
| t₁ = 25 mm, d₁ = 10 μm | | |
| The filter sheets at two ends: ρ₂ = 50 kg/m³, | 0.97b | 71% |
| t₂ = 50 mm, d₂ = 2 μm; | | |
| The intermediate filter sheets: ρ₁ = 40 kg/m³, | | |
| t₁ = 30 mm, d₁ = 5 μm | | |
| The filter sheets at two ends: ρ₂ = 15 kg/m³, | 1.05b | 59% |
| t₂ = 5 mm, d₂ = 15 μm; | | |
| The intermediate filter sheets: ρ₁ = 5 kg/m³, | | |
| t₁ = 10 mm, d₁ = 20 μm | | |

Each of the filter sheets at two ends of the filter core 6 may have an axial center hole. In the case of the intermediate filter sheet 5 being provided between the filter core 6 and the cartridge 7, most of the impurities in the refrigerant are filtered by the intermediate filter sheet 5, thus the requirement for the filtration capacity of the filter sheets at two ends of the filter core 6 is not high. Center holes with relatively small size are provided in the filter sheets at two ends of the filter core 6 and are close to the outlets. Thus, part of the refrigerant may directly flow out via the center hole, small part of unfiltered impurities may be still filtered by the sieves, such that the fluid flux is further increased and the filtration capacity will not be to affected.

The bi-flow filter drier provided by the present application is described in detail hereinbefore. The principle and the embodiments of the present application are illustrated by specific examples. The above description of examples is only intended to help the understanding of the method and the spirit of the present application. It should be noted that, for the person skilled in the art, many modifications and improvements may be made to the present application without departing from the principle of the present application, and these modifications and improvements are also deemed to fall into the protection scope of the present application defined by the claims.

What is claimed is:

1. A bi-flow filter drier comprising a cartridge, a filter sheet being provided at each of two ends of the filter core, wherein the bi-flow filter drier further comprises at least one intermediate filter sheet positioned between the cartridge and the filter core.

2. The bi-flow filter drier according to claim 1, wherein a periphery of a cross section of the intermediate filter sheet is of polygonal shape, side edges of the intermediate filter sheet abut against an inner wall of the cartridge, the intermediate filter sheet has an axial through hole, and a wall of the axial through hole abuts against the periphery of the filter core.

3. The bi-flow filter drier according to claim 1, wherein the number of the intermediate filter sheet is more than one, and an overall axial thickness of the intermediate filter sheets is equal to an axial length of the filter core.

4. The bi-flow filter drier according to claim 3, wherein an axial center hole is provided in each of the filter sheets at two ends of the filter core.

5. The bi-flow filter drier according to claim 4, wherein the intermediate filter sheets are made of glass wool board and the filter sheets at two ends of the filter core are made of glass wool felt.

6. The bi-flow filter drier according to claim 5, wherein the glass wool board has a density ρ₁ meeting an expression of 25 kg/m³≦ρ₁≦50 kg/m³, and the glass wool felt has a density ρ₂ meeting an expression of 10 kg/m³≦ρ₂≦40 kg/m³.

7. The bi-flow filter drier according to claim 6, wherein a minimum thickness of the intermediate filter sheets is larger than 5 mm.

8. The bi-flow filter drier according to claim 2, wherein more than one intermediate filter sheet is provided, and an overall axial thickness of the intermediate filter sheets is equal to an axial length of the filter core.

9. The bi-flow filter drier according to claim 8, wherein an axial center hole is provided in each of the filter sheets at two ends of the filter core.

10. The bi-flow filter drier according to claim 9, wherein the intermediate filter sheets are made of glass wool board and the filter sheets at two ends of the filter core are made of glass wool felt.

11. The bi-flow filter drier according to claim 10, wherein the glass wool board has a density ρ₁ meeting an expression of 25 kg/m³≦ρ₁≦50 kg/m³, and the glass wool felt has a density ρ₂ meeting an expression of 10 kg/m³≦ρ₂≦40 kg/m³.

12. The bi-flow filter drier according to claim 11, wherein a minimum thickness of the intermediate filter sheets is larger than 5 mm.
